(19) United States
(12) Patent Application Publication
(10) Pub. No.: US 2006/0066788 A1
(43) Pub. Date: Mar. 30, 2006

(54) Liquid crystal display apparatus

(76) Inventors: Yuka Utsumi, Hitachi (JP); Yasushi Tomioka, Hitachinaka (JP); Masaki Matsumori, Hitachi (JP); Shigeru Matsuyama, Mobara (JP); Noboru Kunimatsu, Chiba (JP); Tsunenori Yamamoto, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/205,207

(22) Filed: Aug. 17, 2005

(30) Foreign Application Priority Data
Sep. 24, 2004 (JP) 2004-276349

(51) Int. Cl. G02F 1/1335

(52) U.S. Cl. 349/120

(57) ABSTRACT

A liquid crystal display apparatus including one pair of substrates, at least one of said substrates being transparent, one pair of polarizing plates arranged on the paired substrates respectively, a liquid crystal layer sandwiched by the paired substrates, a liquid crystal display panel in which an electrode group is formed on at least one of the paired substrates and is to apply an electric field to the liquid crystal layer, and a light source unit arranged on a rear surface of the liquid crystal display panel, a monoaxial absorption anisotropic layer provided between the paired polarizing plates. In such apparatus, a high contrast ratio can be achieved due to suppression of black luminance. Also, better display qualities can be achieved by reducing a blue changing phenomenon of black representation.

### BACKGROUND OF THE INVENTION

1. Field of the Invention

The present invention is related to a liquid crystal display panel substrate containing a member representative of monoaxial absorption anisotropy, and related to a liquid crystal display panel, and also to a liquid crystal display apparatus, which use this liquid crystal display panel substrate.

2. Description of the Related Art

Usage of liquid crystal displays has been expanded because of the following merits, namely liquid crystal displays can be made slim and in light weight, and further, viewing angle enlarging techniques and moving picture techniques have been developed/progressed, as compared with CRTs (cathode-ray tubes; generally speaking, will be referred as “Braun tubes”) which may constitute a major component of conventional display apparatus.

Very recently, the usage of such liquid crystal displays has been expanded as monitors used in desk-top type personal computers, monitors used in printing operations and designing fields, or liquid crystal television receivers, so that strong needs as to better color reproducibility and high contrast ratios are made. In particular, black representations may constitute very important factors, and also, high luminance is strongly required in liquid crystal television receivers.

Tastes in color tones may largely give influences with respect to image qualities of liquid crystal television receivers. For instance, white representations of liquid crystal television receivers are not set to achromatic colors on a chromatic theory, but may be sometimes set to a high color temperature, namely 9,300° K, and furthermore, may be set to such a color temperature higher than, or equal to 10,000° K in Japan.

On the other hand, in a liquid crystal display apparatus for displaying information by employing one pair of polarizing plates, both a white representation and a black representation are strongly controlled based upon transmission characteristics as to an orthogonal polarizing plate and a parallel polarizing plate of the employed polarizing plates. In other words, the black representation is influenced by the orthogonal transmittance of the polarizing plate, whereas the white representation is influenced by the parallel transmittance of this polarizing plate. Such a condition that the orthogonal transmittance is low and the parallel transmittance is high is required so as to achieve the high contrast ratio. In the case of such a polarized plate which has been aligned in a poly-vinyl alcohol resin where iodine has been extended, there are many possibilities that a contrast ratio as to a short wavelength range is lowered. This reason may be conceived as follows. That is, it is practically difficult to perfectly control order parameters as to iodine and the resin. Under this reason, the black representation is high and the white representation is low in the short wavelength range, namely in the blue transmitted light, as compared with the transmitted light in the long wavelength range. When a high color temperature is set in a white representation, namely, the color temperature is set in white where a blueness is emphasized, a blueness of a black representation is emphasized, which may cause a problem in a liquid crystal television receiver in which a black representation may constitute an important factor.

As a means capable of solving the above-described color difference problem as to the black and white representations which is caused by the polarizing plate, the corrected color polarizing plate technique is reported in SID03, pages 824 to 827. Also, JP-A-2003-29724 discloses such a technical idea capable of correcting a chromatone of low gradation in a PVA (Patterned Vertical Alignment) mode of a liquid crystal display apparatus.

As previously explained, the liquid crystal display apparatus for displaying information by the polarized light owns such a problem that the chromatone of the black representation and the chromatone of the white representation are largely changed by mainly the difference between the spectral characteristic of the orthogonal transmittance and the spectral characteristic of the parallel transmittance of the polarized plate, and thus, the blueness in the black representation is emphasized.

The above-described technical idea of JP-A-2003-29724 is independently capable of controlling the three color (RGB) pixels so as to correct the chromatone. However, in order to improve the achromatic color with respect to the blue transmitted light, both the green transmitted light and the red transmitted light must be increased. If this method is conducted to the black representation, the luminance of the black representation is caused to be increased, so that lowering of the contrast ratio is not avoidable. In the liquid crystal television receiver in which the black representation constitutes the major factor, occurrences of the following phenomenon cannot be allowed, namely, the luminance of the black representation is increased and the contrast ratio is lowered. Also, if a black representation is performed under such a condition that alignment states of liquid crystal molecules in the respective RGB pixels are different from each other, then a viewing angle property is deteriorated. This deterioration also cause another problem.

As to the corrected chromatone polarizing plates capable of improving the achromatic coloring process of the polarizing plate orthogonal transmittance characteristic by arranging the color matters indicative of the dichroism in the short wavelength range outside one pair of the polarizing plates, which has been published in “Thin Crystal Films (TCF) for LCD Color Correction; Louis D. Silverstein et al, SID 03 DIGEST, pages 824 to 827, since four sets of the polarization layers are formed, such a process for aligning the respective axes thereof with each other is necessarily required. As a result, it is avoidable that the load given by the production process is increased.

Also, a fluctuation in polarization degrees of a polarizing plate may conduct a fluctuation in display qualities, which may also cause another problem in view of productivity. For instance, as indicated by a solid line and a broken line in FIG. 10, a polarization degree of a polarizing plate is largely fluctuated due to a quality of this polarizing plate. In this case, a display quality as to a liquid crystal display panel which employs the polarizing plate indicated by the above-described solid line is largely different from a display quality as to another liquid crystal display panel which employs the polarizing plate indicated by the above-described broken line.

### SUMMARY OF THE INVENTION

As a result of researches made by the Inventors of the present invention, the Inventors could invent the following method capable of solve the above-explained problems by such a manner that an organic layer having absorption anisotropy for light along one direction is formed on a liquid crystal substrate, and a liquid crystal display panel is arranged by employing the liquid crystal substrate having the anisotropy. That is to say, the inventive method can reduce a chromaticity change in a white representation and a black representation, and also, can reduce luminance of the black representation so as to improve a contrast ratio. Also, an object of the present invention is to achieve an effect capable of compensating lowering of a polarization degree of a polarized plate, and therefore, has an object to improve a production margin with respect to a fluctuation in polarization degrees of a polarizing plate in addition to an effect of improving an image quality.

It should also be understood that in accordance with the above-described corrected chromatone polarizing plate technique, since there is an adverse influence for canceling polarization due to lowering of the alignment degree of the color matter, the above-described organic layer having the monoaxial absorption anisotropy cannot be formed inside the polarizing plate, namely on the substrate.

A liquid crystal display apparatus according to the present invention owns the following basic idea. That is, since a polarized light status is changed by that linearly-polarized light which has transmitted a high-incident-sided polarizing plate (namely, polarizing plate 13 of FIG. 1) is changed by a liquid crystal layer, an amount of light which passes through a light-projection-sided polarizing plate (namely, polarizing plate 14 of FIG. 1) is controlled. As to a black representation in this liquid crystal display apparatus, there is no change in a polarized light condition by the liquid crystal layer in an ideal case, light of a light source is cut off by the light-projection-sided polarizing plate 14 which is orthogonally arranged with respect to the light-incident-sided polarizing plate 13. As a consequence, an ideal black representation may be realized by such a product made by multiplying an orthogonal transmittance of an employed polarizing plate by spectral transmittance of a color filter. Precisely speaking, although light is absorbed by a substrate, an insulating layer, a transparent electrode, and the like, the light is mainly absorbed by the polarizing plate and the color filter. Both a gray scale representation and a white representation in which light is transmitted may be realized by that birefregent light produced by the liquid crystal layer passes through the light-projection-sided polarizing plate 14. As a consequence, the ideal white representation is mainly effected by both the birefregent light of the liquid crystal in accordance with the parallel transmittance of the employed polarizing plate, and the spectral transmittance of the color filter. On the other hand, as represented in FIG. 10, since the polarization degree of the polarizing plate is lowered in the short wavelength range, a black color is represented in a blue color in a black representation, and transmittance of the blue color is lowered in a white representation. Also, as represented in the characteristics indicated by the solid line and the broken line, there are some cases that the polarization degrees may largely collapse. On the other hand, in the black representation, since the light is scattered by the pigment particles for constituting the color filter layer and by the liquid crystal layer, leakage light may be produced, so that the luminance is increased and the chromatone is changed from the ideal black representation. As a consequence, since the monoaxial anisotropy is applied to the substrate, the polarization degree in the short wavelength range may be improved by adjusting the polarization degree of the polarizing plate, and the fluctuation of the polarization degree may be compensated, and also, the generated leakage light may be absorbed, so that the luminance of the black representation can be reduced and the blueness can be reduced. This monoaxial anisotropy is applied to a layer by irradiating thereto such a light which has been substantially polarized, so that this layer having the monoaxial anisotropy can be arranged on the substrate, namely can be arranged between the polarizing plates.

FIG. 1 is a sectional view for showing a structure of a liquid crystal display apparatus in a conceptional manner, according to the present invention. It should be noted that such detailed structural elements as electrodes, insulating films, spacers, and a light source have been omitted from FIG. 1. Referring now to FIG. 1, a description is made of a means capable of solving the problems, according to the present invention. The liquid crystal display apparatus is arranged by an optical source unit 31 and a liquid crystal panel 30. This liquid crystal panel 30 is constituted by one pair of substrates 11 and 12 in which a plurality of electrode groups have been formed on at least one of these paired substrates; polarizing plates 13 and 14 which are arranged outside the respective substrates 11 and 12; a liquid crystal layer 21 which is sandwiched by one pair of the substrates 11 and 12; alignment layers 22 and 23 for aligning liquid crystal molecules along a predetermined direction; and also, a color filter layer 24 used to display thereon information in a color mode.

As one example of the structure of the liquid crystal display apparatus according to the present invention, an anisotropic film 41 is formed as a layer which indicates anisotropy of an absorption between the color filter layer 21 and the alignment filter 22. This anisotropic layer 41 may be formed as an organic layer which also has a function of an overcoat layer when the color filter layer 24 is formed, or may be separately formed. At this time, in such a case that the anisotropy of the absorption is present over the visible wavelength range, there are such effects that the luminance of the black representation may be reduced, the contrast ratio may be improved, and also, the margin with respect to the large fluctuation of the polarization degree of the polarizing plate may be improved. Further, there is another effect that the productivity may be improved. Also, in such a case that the transmitted light of the short wavelength range shorter than, or equal to 500 nm is selectively absorbed, the blueness of the black representation may be reduced, the chromaticity difference between the white representation and the black representation may be lowered, and the contrast ratio may be improved. As a concrete means for forming an anisotropic layer, such a photosensitive resin is employed which represents anisotropy of an absorption along a direction of a polarization plane of irradiated light, or along a direction perpendicular to this polarization plane, while such a light which has been substantially linearly polarized is irradiated to this photosensitive resin. Alternatively, such a chemical compound having a photosensitivity, for instance, a chemical compound having an azo benzene skeleton may be added to the above-explained photosensitive resin so as to strengthen the anisotropy thereof. At this time, since a wavelength indicative of an absorption is selected, the anisotropy may be applied over the substantially visible light range. In this alternative case, since the polarization degree of the polarizing plate is strongly aided, the higher effect capable of improving the productivity may be expected. Since wavelengths indicative of anisotropy and strengths thereof are determined based upon a light irradiation condition, these conditional items may be properly optimized. Since the inner plane precision of the absorption axis becomes better by employing such a method for applying monoaxial anisotropy by irradiating the substantially-linearly polarized light, the absorption axis of the monoaxial anisotropic layer may be arranged between one pair of the polarizing plates 13 and 14, namely arranged between the substrates 11 and 12.

As another structural example of the liquid crystal display apparatus according to the present invention, while such a layer having the anisotropy of the absorption is not newly provided, such a structure is provided which may cause a color filter layer to represent the anisotropy of the absorption. As a method for representing the anisotropy, such a photosensitive group which is made of, for example, an azo benzene skeleton may be conducted to a binder resin in a composition of a color filter resist as a side chain, or such a compound made of this photosensitive group may be conducted to the above-explained binder. Since light which has been substantially linearly polarized is irradiated to this photosensitive group, this photosensitive group represents the anisotropy of the absorption along the direction of the polarization plane of the irradiated light, or along the direction perpendicular to the polarization plane. Since the anisotropy of the absorption is represented only in such a case that a blue color is represented, the light leakage of the black representation can be reduced and also the blueness can be compensated without giving an adverse influence to the wavelength of the blue color, or the wavelength of the red color.

Also, as another structural example of the liquid crystal display apparatus according to the present invention, such a structural example may be conceived. That is, a resin having anisotropy of an absorption is employed in a resist as to each of RGB pixels of a color filter layer. If compounds indicative of absorption wavelengths corresponding to the respective color wavelengths are selected to be added, then lowering of the light leakage in the black representation can be improved over the entire range of the visible light wavelengths. As a result, such effects can be obtained that the contrast ratio can be largely improved, and the margin for productivity with respect to the fluctuations of the polarizing plates can be enlarged.

Also, as another structural example of the liquid crystal display apparatus according to the present invention, such a structural example may be conceived. That is, in the case such a liquid crystal display apparatus that the color filter layer 24 is formed on the substrate 11 on the side of the light source 31, for instance, this color filter layer 24 is formed on an active matrix substrate, the anisotropic film 41 may be formed on the substrate 12 independent from the color filter layer 24.

Also, as another structural example of the liquid crystal display apparatus according to the present invention, such a structural example may be conceived. That is, the anisotropic film 41 may be formed between the substrate 12 and the color filter layer 24, or may be formed in the substrate 12, and thereafter, the polarizing plate 14 may be adhered onto the anisotropy layer. Since such structural elements for producing the leaked light, for example, reflections and interference by the liquid crystal layer, the color filter layer, and the electrodes are provided in the liquid crystal display cell, if the anisotropic layer is arranged at a nearer position with respect to the light-projection-sided polarizing plate 14, then there is such an effect that the leaked light can be absorbed.

As apparent from the foregoing explanation, even when the anisotropic layer is formed at a position for compensating the polarization degree of the light-incident-sided polarizing plate 13, namely on the side of the substrate 11, the effect of capable of improving the polarization degree may be achieved. Such a fact that if the polarized light having the high polarization degree is entered, then the luminance of the black representation can be lowered, may have such a similar meaning that a polarizing plate having a higher polarization degree within two sorts of the polarizing plates shown in FIG. 10 can reduce the luminance of the black representation.

In accordance with the present invention, even when a single anisotropic layer is employed, the above-described effect may be achieved. Even in such a case that a plurality of anisotropic layers are conducted, for instance, anisotropic layers are formed on both the polarizing plates 11 and 12, it is apparent that an effect of improving a contrast ratio may be achieved.

In the case that an isotropic layer is formed on such a substrate on the side of an observer, namely, the light-projection-sided substrate 12 shown in FIG. 1, a polarization plane of light to be irradiated is determined in such a manner that an axis indicative of the absorption of the anisotropic layer becomes substantially parallel to the absorption axis of the light-projection-sided polarizing plate. Since this arrangement is employed, the leakage light which is not favorable in the black representation can be absorbed, and light other than this leakage light can be transmitted. In the gray scale representation and the white representation, the birefregent light which has been generated by the liquid crystal layer whose alignment direction has been changed by applying thereto the voltage can be transmitted without any absorption. This is because the birefregent light generated by the liquid crystal layer corresponds to such a light projected from the direction perpendicular to the absorption axis of the light-projection-sided polarizing plate. In the case that an isotropic layer is formed on such a substrate on the side of a light source, namely, the light-incident-sided substrate 13 shown in FIG. 1, a polarization plane of light to be irradiated is determined in such a manner that an axis indicative of the absorption of the anisotropic layer becomes substantially parallel to the absorption axis of the light-incident-sided polarizing plate. Since this arrangement is employed, an effect capable of aiding the polarization degree of the light-incident-sided polarizing plate may be achieved.

As to an alignment control film used to align liquid crystal, in such a case that a so-called “optical aligning-alignment film is employed which may apply a liquid crystal alignment capability by irradiating thereto light which has been substantially linearly polarized, if such a material is selected, then light irradiating process operations may be carried out in a batch manner. In this selected material, the liquid crystal alignment axis applied with respect to the polarization plane of the light to be irradiated is made coincident with the direction along which the absorption axis of the monoaxial anisotropic layer is presented. In accordance with this method, since the alignment vector of the liquid crystal is made substantially coincident with the absorption axis of the anisotropic layer, this method may give a merit that precision for aligning the axes may be improved.

Although the present invention is not limited only to the below-mentioned materials, as an example of materials used to form an anisotropic layer, for instance, such an organic compound is added to either an overcoat layer resin of a color filter layer or each of RGB color photosensitive resists. This organic compound has a linear rod-shaped molecular structure having high anisotropy. As an example of this linear rod-shaped molecule having the high anisotropy, the following chemical compounds may be conceived: chrysophenine, Direct Fast Yellow GC, Kayarus Supra Orange 2 GL, Direct Fast Scarlet 4 BS, Kayaku Direct Scarlet BA, Diacotton Phoduline Red B, Congo Red, Dialuminous Red 4B, Dialuminous Red 4BL, Diacotton Violet X, Nippon Brilliant Violet BK, Sumilight Supra Blue G, Sumilight Supra Blue FGL, Diacotton Brilliant Blue RW, Diacotton Sky Blue 6B, Diacotton Copper Blue BB, Direct Dark Green BA, Kayaku Direct Fast Black D, and the following compounds having the respective skeletons of: poly azo series, Benziodine, diphenyl urea series, stilbene series, dinaphthyl amine series, anthraquinone series, azo series, anthraquinone series, and so on. After these layers have been formed, ultraviolet rays which have been substantially linearly polarized are irradiated to these layers, and then, these layers are heated. As a result, such a monoaxial absorption layer may be formed which has an absorption axis along such a direction perpendicular to the axis of the irradiated linearly polarized light. As the compound which is added to the overcoat layer, for example, if Direct Fast Yellow is employed, then anisotropy mainly appears on the side of the short wavelength side, and a blueness of a black representation may be effectively improved. In such a case that compounds are added to a color photosensitive resist, there is a merit when such a selection is made in order that a maximum absorption wavelength of each of colors is made coincident with a maximum absorption wavelength of each of the compounds, for example, if a red color is employed, then Sumilight Supra Blue is added; if a green color is employed, then Dialuminous Red is added; and if a blue color is employed, then Direct Fast Yellow is added.

Alternatively, ultraviolet rays which have been linearly polarized are irradiated to such a resin of an overcoat layer, and then, the irradiated resin is heat-processed, so that anisotropy having a monoaxial absorption may be applied. This overcoat layer employs polymers having a relatively linear structural unit, for instance, having a carboxyl group where epoxy acrylate is employed as a base, and having a fluorene skeleton. In this alternative case, a dichroic ratio is lowered, as compared with the dichroic ratio obtained in the case that the above-explained compounds are employed. However, this alternative case may effectively compensate for the higher polarization degree in the case that the polarizing plate having the sufficiently high polarization degree is employed. In such a case that the dichroic ratio of the anisotropic layer which is larger than, or equal to 10 is obtained by employing the above-explained compound, even when the polarization degree of the polarizing plate is fluctuated to small values, there is a merit that this polarization degree may be compensated.

Also, in such a case that an anisotropic layer is wanted to be formed on the side of a TFT (thin-film transistor), such a resin which is similar to that of the above-explained overcoat layer may be formed on the TFT substrate.

Since the substrate is combined with such an alignment film to which a liquid crystal alignment capability is applied by irradiating the linearly polarized ultraviolet rays and by heating the alignment film, both the alignment process operation and the monoaxial absorption anisotropic process operation can be carried out in a batch manner. As a result, while there is no process increased, there is a merit as to an axial precision aspect.

Alternatively, in such a case that an anisotropic layer is formed outside a substrate, this anisotropic layer may be formed as follows: That is, for instance, the above-explained compound is added to a transparent resin such as polyvinyle alchole, polyethylene terephtalate, polyolefine, epoxy acrylate, polyimide and the like. After this resulting transparent resin has been coated, or printed on the outer side of the substrate, ultraviolet rays which have been linearly polarized are irradiated to this coated/printed transparent resin, and then, the resulting transparent resin may be heated so as to form such an anisotropic layer. In such a case that a resin capable of forming a self-holding film is employed, after this resin has been adhered to a substrate, ultraviolet rays may be irradiated to this adhered resin, which will be then heating-processed.

As concrete means for accomplishing the liquid crystal display apparatus of the present invention, the below-mentioned structures may be conceived.

A liquid crystal display apparatus may be arranged by comprising: one pair of substrates; one pair of polarizing plates which are arranged on the one pair of substrates respectively; a liquid crystal layer which is sandwiched by the one pair of substrates; an electrode group which is formed on at least one of the one pair of substrates and is to apply an electric field to the liquid crystal layer; and a light source which is arranged outside the one pair of substrates; in which a layer having monoaxial absorption anisotropy is provided between the one pair of polarizing plates, while the layer owns an absorption axis along one direction and light is transmitted through the layer along the other direction.

Also, the layer having the monoaxial absorption anisotropy may own a material which indicates the monoaxial absorption anisotropy by irrating thereto light which has been substantially linearly polarized.

Also, at least one of the paired substrates may have monoaxial absorption isotropy.

Also, the layer having the monoaxial absorption anisotropy may own a function capable of protecting a colored layer. The layer having the monoaxial absorption anisotropy may correspond to at least one color filter of a colored layer. The layer having the monoaxial absorption anisotropy may correspond to an insulating layer formed on an active matrix substrate.

Also, monoaxial absorption anisotropy in a short wavelength range shorter than, equal to 500 nm may be made stronger than monoaxial absorption anisotropy in a long wavelength range longer than 500 nm.

Also, one of the paired substrates may correspond to an active matrix substrate where the electrode group has been formed; and the other substrate located opposite to the active matrix substrate may own monoaxial absorption anisotropy. Also, one of the paired substrates may correspond to an active matrix substrate where sid electrode group has been formed; and the active matrix substrate may own monoaxial absorption anisotropy.

Also, the absorption axis of the layer having the monoaxial absorption anisotropy may be located substantially parallel to an absorption axis of any one of the paired polarizing plates.

Also, a long axial direction of a liquid crystal molecule which constitutes the liquid crystal layer on an alignment control film formed on the paired substrates may be located substantially parallel to, or substantially vertical to the absorption axis of the layer having the monoaxial absorption anistorpy, which has been formed on the substrate provided on the side of the observer. Otherwise, a long axial direction of a liquid crystal molecule which constitutes the liquid crystal layer on an alignment control film formed on the paired substrates may be located in a substantially vertical direction with respect to the alignment control film.

Also, a liquid crystal display apparatus may be arranged by comprising: one pair of substrates; one pair of polarizing plates which are arranged on the one pair of substrates respectively; a liquid crystal layer which is sandwiched by the one pair of substrates; an electrode group which is formed on at least one of the one pair of substrates and is to apply an electric field to the liquid crystal layer; and a light source which is arranged outside the one pair of substrates; in which an absorption layer for compensating polarization degrees of the one pair of polarizing plates is formed on at least one of the paired polarizing plates.

Further, a liquid crystal display panel may be arranged by comprising: one pair of substrates; one pair of polarizing plates which are arranged on the one pair of substrates respectively; a liquid crystal layer which is sandwiched by the one pair of substrates; and an electrode group which is formed on at least one of the one pair of substrates and is to apply an electric field to the liquid crystal layer; in which a layer having monoaxial absorption anisotropy is provided between the one pair of polarizing plates.

As previously described in detail, in accordance with the liquid crystal display apparatus of the present invention, the luminance of the black representation thereof is lowered, and the high contrast ratio is achieved, so that the blue changing phenomenon of the black representation can be reduced. Also, since the fluctuation in the polarization degrees of the polarizing plate can be compensated, the productivity can be improved.

### BRIEF DESCRIPTION OF THE DRAWINGS

FIG. 1 is a sectional view for schematically indicating one example of a structure of a liquid crystal display according to the present invention.

FIG. 2 is a sectional view for schematically representing an area in the vicinity of one pixel corresponding to an example of a use mode in the liquid crystal display according to the present invention.

FIG. 3 is a schematic diagram for showing an area in the vicinity of one pixel of an active matrix substrate corresponding to an example of a use mode in the liquid crystal display according to the present invention.

FIG. 4 is a schematic diagram for indicating an area in the vicinity of one picture element of a color filter substrate corresponding to one example of a use mode in the liquid crystal display according to the present invention.

FIG. 5 is a sectional view for schematically representing an area in the vicinity of one pixel corresponding to an example of a use mode in the liquid crystal display according to the present invention.

FIG. 6 is a schematic diagram for showing a structure of a thin-film transistor of an active matrix substrate corresponding to an example of a use mode in the liquid crystal display according to the present invention.

FIG. 7 is a schematic diagram for showing an area in the vicinity of one pixel of an active matrix substrate corresponding to an example of a use mode in the liquid crystal display according to the present invention.

FIG. 8 is a schematic diagram for indicating an area in the vicinity of one picture element of a color filter substrate corresponding to one example of a use mode in the liquid crystal display according to the present invention.

FIG. 9 is a sectional view for schematically representing an area in the vicinity of one pixel corresponding to an example of a use mode in the liquid crystal display according to the present invention.

FIG. 10 graphically represents a polarization degree characteristic of a polarizing plate.

FIG. 11 is a sectional view for schematically representing an area in the vicinity of one pixel corresponding to an example of a use mode in the liquid crystal display according to the present invention.

FIG. 12 is a schematic block diagram for representing a liquid crystal display apparatus corresponding to an example of a use mode according to the present invention.

FIG. 13 is a sectional view for schematically representing an area in the vicinity of one pixel corresponding to an example of a use mode in the liquid crystal display according to the present invention.

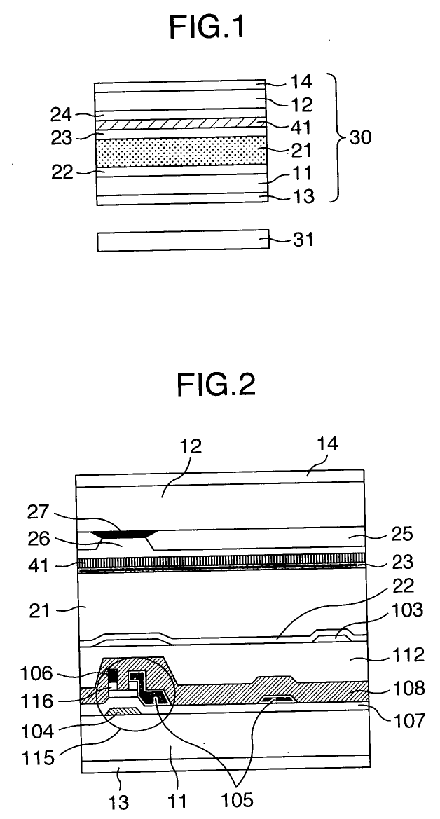

### DETAILED DESCRIPTION OF THE EMBODIMENTS

Referring now to drawings, various embodiment modes for carrying out the present invention will be described in detail.

### Embodiment 1

An embodiment 1 according to the present invention will now be explained with reference to drawings.

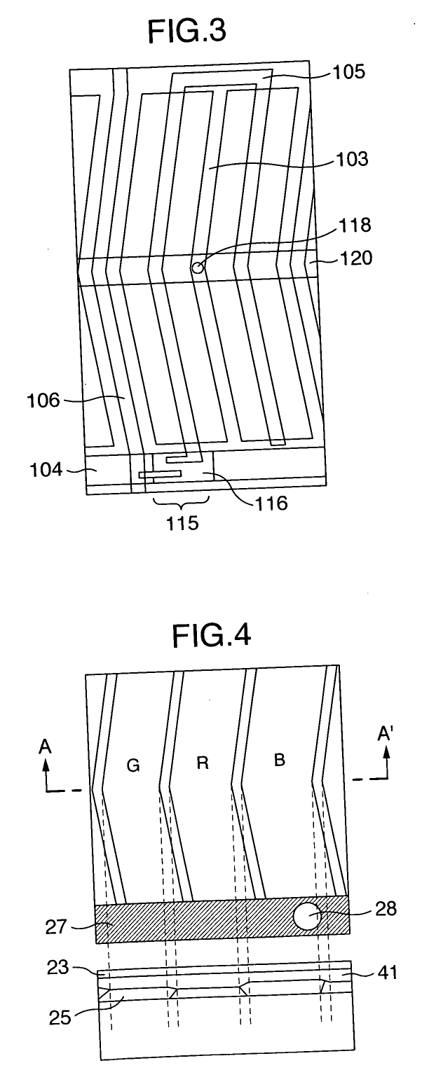

FIG. 2 is a sectional view for schematically representing an area in the vicinity of one pixel, which explains an embodiment mode 1 of a liquid crystal display apparatus according to the present invention. FIG. 3 is a schematic diagram for showing an area in the vicinity of one pixel of an active matrix substrate, which explains the embodiment mode 1 of the liquid crystal display apparatus according to the present invention. FIG. 4 is a schematic diagram for indicating an area in the vicinity of one picture element (R, G, B pixels) of a color filter substrate.

While a liquid crystal display apparatus corresponding to a first embodiment of the present invention is manufactured, a non-alkali glass substrate having a thickness of 0.7 mm was employed as both a substrate 11 which constitutes an active matrix substrate, and another substrate 12 which constitutes a color filter substrate. A thin-film transistor 115 which is formed on the substrate 11 is constituted by a pixel electrode 105, a signal electrode 106, a scanning electrode 104, and a semiconductor film 116. The scanning electrode 104 was formed by patterning an aluminium film; both a common electrode wiring line 120 and the signal electrode 106 were formed by patterning a chromium film; the pixel electrode 105 was formed by patterning an ITO(indium-tin-oxide) film; and the structural components other than the scanning electrode 104 were formed on an electrode wiring pattern which was bent in a zig-zag pattern. In this case, a bending angle was set to 10 degrees. It should be understood that the electrode materials are not limited only to the materials described in the present specification. For example, ITO has been employed in this first embodiment. Alternatively, any of transparent conductive substances may be freely employed, namely, IZO (indium-zinc-oxide), or an inorganic transparent substance may be employed. Similarly, the metal electrodes are not limited only to the above-explained materials. While a gate insulating film 107 and a protection insulating film 108 were made of silicon nitride, each of film thickness thereof was selected to be 0.3 μm. Next, a cylindrical-shaped through hole having a diameter of approximately 10 μm was formed up to the common electrode wiring line 120 by executing both a photolithography method and an etching process operation, on which an acrylic-series resin was coated, and then, a transparent organic insulating film 112 having a film thickness of approximately 3 μm was formed by performing a heating process operation at a temperature of 220° C. for 1 hour. This transparent insulating film 112 owns an insulating characteristic, and the dielectric constant thereof is about 4.

Thereafter, the above-explained through hole portion was again etching-processed with a diameter of approximately 7 μm, on which the common electrode 103 to be connected to the common electrode wiring line 120 was formed by patterning an ITO film. In this case, an interval between the pixel electrode 105 and the common electrode 103 was selected to be 7 μm. Furthermore, this common electrode 103 was formed in a lattice shape in such a manner that the common electrode 103 covers the upper portions as to the signal electrode 106, the scanning electrode 104, and the thin-film transistor 115 so as to surround pixels. A thickness of the formed common electrode 103 was selected to be approximately 80 μm. Active matrix substrates having a total number of pixels of 1024×3×768 pieces were manufactured which are constituted by 1024×3 (corresponding to R, G, B pixels) pieces of the signal electrodes 106, and also, 768 pieces of the scanning electrodes 104.

Next, while a black resist made by Tokyo Ohka kogyo Co., Ltd. was employed, a black matrix was formed on the substrate 12 by executing a photolithography method (namely, standard processing method) through various steps, namely, a coating step, a pre-baking step, an exposing step, a developing step, a rinsing step, and a post-baking step. It should be understood that although the film thickness was selected to be 1.5 μm in this first embodiment, the film thickness may be alternatively matched with an employed black resist in such a manner that the OD value becomes larger than, or equal to approximately 3. Next, while the respective color resists made by Fuji Film Arch Company were employed, a color filter was formed by performing a photolithography method (namely, standard processing method) through various steps, namely, a coating step, a pre-baking step, an exposing step, a developing step, a rinsing step, and a post-baking step. Although film thicknesses as to a B pixel, a G pixel, and an R pixel were selected to be 3.0 μm, 2.8 μm, 2.7 μm, respectively in this first embodiment, these film thicknesses may be properly matched with respect to a desirable color purity, or a desirable liquid crystal layer thickness. Next, in order to obtain a flatness and protect the color filter layer, Direct Orange 39 was added to V-259 made by Nippon Steel Chemical Co., Ltd. by 2 weight percents, and then, an overcoat layer was formed by employing the resultant Direct Orange 39. In the exposing step, light having an amount of 200 mJ/cm² was irradiated onto the overcoat layer by way of i-rays of a high pressure mercury vapor lamp, and thereafter, the black matrix was formed by heating the overcoat layer for 30 minutes at a temperature of 200° C. A film thickness of the overcoat layer was approximately 1.2 to 1.5 μm on color pixels. Next, a pillar-shaped spacer was formed at a height of approximately 3.8 μm on such a black matrix sandwiched by B pixels by performing both a photolithography method and an etching process (namely, standard processing methods), while a photosensitive resin was employed. It should also be noted that the position of the pillar-shaped spacer is not limited only to the above-explained position of this first embodiment, but may be arbitrarily set, if required. Also, in this first embodiment, the black matrix was formed in the area which is overlapped with the scanning electrode 104 of the TFT substrate, and the pixels where different colors thereof are adjacent to each other were formed in such a manner that the respective colors are overlapped with each other. Alternatively, the black matrix may be formed in this area.

Next, while a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was substantially vertically irradiated onto the substrate in irradiation energy of approximately 5 J/cm², while heating the substrate at a temperature of 230° C. A polarization direction of the irradiated polarized light was selected to be coincident with a short edge direction (for example, signal electrode direction in TFT substrate) of the substrate. After this process operation has been carried out, the following facts could be confirmed. That is, when the color filter substrate is arranged between orthogonal polarizing plates and the substrate is rotated, it could be confirmed that a strength of transmitted light is changed, and further, when the polarized plane of the irradiated ultraviolet rays is rotated at an angle of 45 degrees with respect to the absorption axis of the orthogonal polarizing plate, the strength of the transmitted light becomes maximum. Also, it could be confirmed that the color filter substrate owns the monoaxial anisotropy. Further, as a result of investigation as to anisotropy by employing a polarizing plate, it could be confirmed that the color filter substrate expresses the absorption axis along a long edge direction of the substrate. In this first embodiment, such a material has been employed by which the absorption axis was expressed along the direction perpendicular to the polarization direction of the irradiated polarized light. Alternatively, for example, in such a case that such a material is employed by which an optical oxidation is produced with respect to the polarization direction of the irradiated polarized light, since a direction of an absorption axis is made coincident with the polarized plane of the irradiated polarized light, the irradiating polarized direction may be changed.

Polyamic acid varnish was printed/formed on the TFT substrate and the color filter substrate respectively, and was thermal-processed at a temperature of 210° C. for 30 minutes so as to form an alignment film 23 which was rubbing-processed. This alignment film 23 is made of a close polyimide film having a thickness of approximately 100 nm. There is no specific limitation as to the alignment film material of this first embodiment, while 2,2-bis [4-(p-aminophenoxy)phenylpropane] may be employed as diamine; polyimide using pyromellitic acid anhydride may be employed as acid anhydride; and paraphenylenediamine, diaminophenylemethane, or the like may be employed as an amine component, either fatty acid tetracarboxylic acid anhydride or polyimide where anhydride is employed in pyromellitic acid may be employed as acidanhydride. The liquid crystal alignment direction was set to the short edge direction (for example, signal electrode direction in TFT substrate) of the substrate.

Next, two sheets of these substrates were arranged in such a manner that the surfaces thereof having alignment films 22 and 23 were located opposite to each other, and a sealing agent was coated on peripheral portions, so that a liquid crystal display panel was assembled which will constitute a liquid crystal display apparatus. These alignment films 22 and 23 own liquid crystal alignment capabilities. A nematic liquid crystal composition was injected into this liquid crystal display panel under vacuum condition, and then the resultant liquid crystal display panel was sealed by such a sealing member made of an ultraviolet ray hardening type resin. As to the above-explained nematic liquid crystal composition, dielectric constant anisotropy thereof is positive; a value thereof is 10.2 (1 KHz, 20° C.); and refractive index anisotropy thereof is 0.075 (wavelength=590 nm, 20° C.).

Two sheets of polarizing plates 13 and 14 ere adhered onto this liquid crystal display panel. While a transmission axis of the polarizing plate 13 was set to the long edge direction (scanning electrode direction) of the liquid crystal display panel, the polarizing plate 14 was arranged along a direction perpendicular to this transmission axis. It should be understood that as the polarizing plates 13 and 14, a viewing angle compensating polarizing plate was employed which is provided with a birefringent film capable of compensating a viewing angle characteristic of a wavelength dispersion owned by refractive index anisotropy of a polarizing plate and a liquid crystal material. In a lateral electric field type liquid crystal display devices according to this first embodiment, the viewing angle characteristics from the gray scale to the white representation originally represent very superior. In addition, since the viewing angle compensating polarizing plate is employed, such a liquid crystal display device capable of indicating a very wide viewing angle characteristic even in the black representation can be achieved. Thereafter, a drive circuit, a back light unit, and the like are connected to the above-described liquid crystal display device so as to construct a liquid crystal display module, so that a liquid crystal display apparatus is accomplished.

Subsequently, when display qualities of this liquid crystal display apparatus were evaluated, it can be confirmed that a contrast ratio is higher than, or equal to 500, a chromaticity difference Δu′ v′ of both the black representation and the white representation is 0.035, and thus, better display qualities can be obtained.

### COMPARISON EXAMPLE 1

In this comparison example 1, the polarized ultraviolet ray irradiating process operation to the color filter substrate employed in the first embodiment is not carried out, so that the color filter substrate does not own the monoaxial absorption anisotropy. Other structures of this comparison example 1 are made similar to those of the first embodiment. In this liquid crystal display apparatus as the comparison example 1, it could be confirmed that a contrast ratio is 420, and a chromaticity difference Δu′ v′ of both the black representation and the white representation is 0.053.

### Embodiment 2

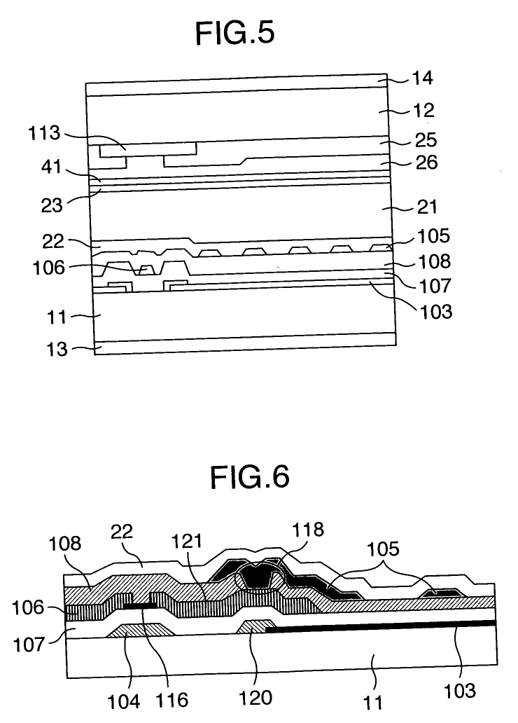

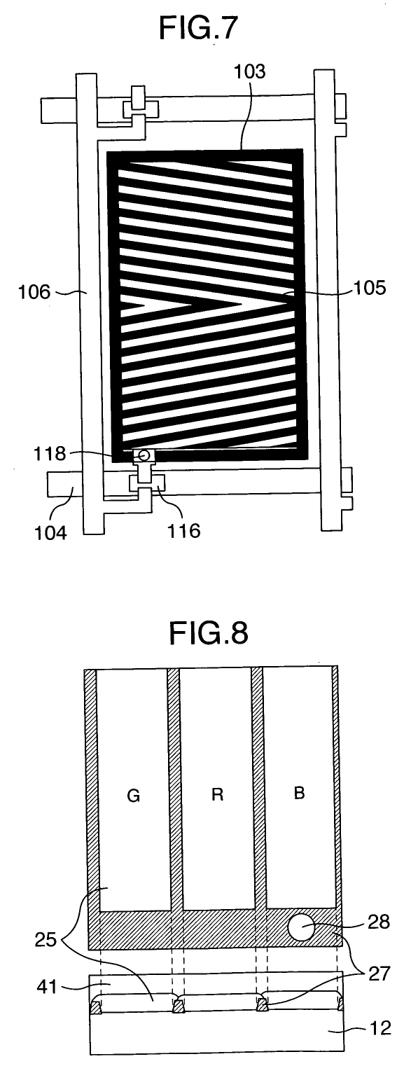

FIG. 5 and FIG. 6 are sectional views for schematically representing an area in the vicinity of one pixel, which explains an embodiment mode 2 of a liquid crystal display according to the present invention. Also, FIG. 7 is a schematic diagram for showing an active matrix substrate for explaining a structure of an area in the vicinity of one pixel used to explain the liquid crystal display according to the resent invention. FIG. 8 is a schematic diagram for describing a structure of an area in the vicinity of one picture element (R, G, B pixels) of a color filter substrate.

S In this second embodiment, a common electrode 103 made of ITO (indium-tin-oxide) has been arranged on a substrate 11 provided as an active matrix substrate; both a scanning electrode (gate electrode) 104 and a common electrode wiring line (common wiring line) 120, which are made of Mo/Al (molybdenum/aluminium), have been formed in such a manner that these scanning electrode 104 and common electrode wiring line 120 are overlapped with the ITO common electrode 103; and a gate insulating film 107 made of silicon nitride has been formed in such a manner that this gate insulating film 107 covers the common electrode 103, the scanning electrode 104, and the common electrode wiring line 120. Also, a semiconductor film 116 made of either amorphous silicon or polysilicon has been arranged via the gate insulating film 107 on the scanning electrode 104, and this semiconductor film 116 may function as an active layer of a thin-film transistor (TFT) as an active element. Also, a picture signal electrode (drain electrode) 106 made of Cr/Mo (chromium/molybdenum), and a pixel electrode (source electrode) wiring line 121 have been arranged in such a manner that the picture signal electrode 106 and the pixel electrode wiring line 121 are superimposed with a portion of the pattern of the semiconductor film 116. Then, a protection insulating film 108 made of silicon nitride has been formed in such a way that this protection insulating film 108 may cover all of the above-described structural elements 103, 104, 120, and 116.

Also, as schematically shown in FIG. 6 an ITO pixel electrode (source electrode) 105 has been arranged on the protection insulating film 108, while this ITO pixel electrode 105 is connected to a metal (Cr/Mo) pixel electrode (source electrode) wiring line 121 via a through hole 118 which has been formed via the protection insulating film 108. Also, as can be understood from FIG. 7, the ITO common electrode (common electrode) 103 has been formed in a flat plate shape in an area of one pixel in a plane manner, whereas the ITO pixel electrode (source electrode) 105 has been formed in a comb shape which is inclined at an angle of approximately 10 degrees. Active matrix substrates having a total number of pixels of 1024×3×768 pieces was manufactured which is constituted by 1024×3 (corresponding to R, G, B pixels) pieces of the signal electrodes 106, and also, 768 pieces of the scanning electrodes 104.

Next, polyamic acid varnish was printed/formed, while this polyamic acid varnish is made of such a varnish which is constituted by, as a monomer component, diamine made by mixing 4,4′-diamino azo benzen with 4,4′-diaminobenzophenon in a molar ratio of 6:4, and also, acid anhydride made by mixing pyromellitic acid anhydride with 1,2,3,4-cyclobutane tetracarboxylic acid anhydride in a molar ratio of 1:1. This polyamic acid varnish was thermal-processed at a temperature of 230° C. for 10 minutes so as to form an alignment film 22. This alignment film 22 is made of a close polyimide film having a thickness of approximately 100 nm. Then, ultraviolet rays corresponding to linearly polarized light was irradiated along a direction substantially vertical to the substrate. It should also be understood that as to the alignment film 22 of this second embodiment, no specific limitation is made if such a material is used to which a liquid crystal alignment capability can be applied by linearly polarized ultraviolet rays along a direction perpendicular to a polarization plane. While a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was irradiated onto the substrate in irradiation energy of approximately 1.2 J/cm², while heating the substrate at a temperature of 230° C. In this second embodiment, an initial alignment condition of liquid crystal, namely an alignment direction when no voltage is applied to the liquid crystal may constitute the direction of the scanning electrode 104 shown in FIG. 7, namely, the horizontal direction of this drawing. As a consequence, a polarization plane to which the ultraviolet rays are irradiated corresponds to the short edge side of the substrate, namely, the direction of the signal electrode 106 of FIG. 7.

Next, as indicated in FIG. 7, while a black resist made by Tokyo Ohka kogyo (K.K) was employed, a black matrix was formed on the substrate 12 by executing a photolithography method (namely, standard processing method) through various steps, namely, a coating step, a pre-baking step, an exposing step, a developing step, a rinsing step, and a post-baking step. It should be understood that although the film thickness was selected to be 1.5 μm in this first embodiment, the film thickness may be alternatively matched with an employed black resist in such a manner that the optical density value becomes larger than, or equal to approximately 3. Next, while the respective color resists made by Fuji Film Arch Company were employed, a color filter was formed by performing a photolithography method (namely, standard processing method) through various steps, namely, a coating step, a pre-baking step, an exposing step, a developing step, a rinsing step, and a post-baking step. Although film thicknesses as to a B pixel, a G pixel, and an R pixel were selected to be 3.0 μm, 2.8 μm, 2.7 μm, respectively in this second embodiment, these film thicknesses may be properly matched with respect to a desirable color purity, or a desirable liquid crystal layer thickness. In this second embodiment, the black matrix has been formed in such a manner that this black matrix surrounds 1 pixel. Alternatively, similar to the first embodiment, the black matrix may be formed in an area which is overlapped with the scanning electrode 104 of the TFT substrate, but may not be formed in such an area that different colors are overlapped with each other, and the black matrix may be formed in such a manner that different color resists which are located 15 adjacent to each other are overlapped with each other.

Next, in order to obtain a flatness and protect the color filter layer, a photosensitive resin made of epoxy acrylate series having a fluorene skeleton was coated, and thereafter, light having an amount of 200 mJ/cm² was irradiated onto the photosensitive resin by way of i-rays of a high pressure mercury vapor lamp, and thereafter, an overcoat layer was formed by heating the photosensitive resin for 30 minutes at a temperature of 200° C. A film thickness of the overcoat layer was approximately 1.2 to 1.5 μm on color pixels. Next, a pillar-shaped spacer 28 was formed at a height of approximately 3.8 μm on such a black matrix sandwiched by B pixels by performing both a photolithography method and an etching process (namely, standard processing methods), while a photosensitive resin was employed. It should also be noted that the position of the pillar-shaped spacer is not limited only to the above-explained position of this second embodiment, but may be arbitrarily set, if required.

Next, polyamic acid varnish was printed/formed, while this polyamic acid varnish is made of such a varnish which is constituted by, as a monomer component, diamine made by mixing 4,4′-diamino azo benzen with 4,4′-diaminobenzophenon in a molar ratio of 6:4, and also, acid anhydride made by mixing pyromellitic acid anhydride with 1,2,3,4-cyclobutane tetracarboxylic acid anhydride in a molar ratio of 1:1.

This polyamic acid varnish was thermal-processed at a temperature of 230° C. for 10 minutes so as to form an alignment film 23 (not shown). This alignment film 23 is made of a close polyimide film having a thickness of approximately 100 nm. Then, ultraviolet rays corresponding to linearly polarized light was irradiated along a direction substantially vertical to the substrate. It should also be understood that as to the alignment film 23 of this second embodiment, no specific limitation is made if such a material is used to which a liquid crystal alignment capability can be applied by linearly polarized ultraviolet rays along a direction perpendicular to a polarization plane. While a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was irradiated onto the substrate in irradiation energy of approximately 5 J/cm², while heating the substrate at a temperature of 230° C.

In this second embodiment, while both the liquid crystal alignment direction and the absorption axis of the monoaxial absorption anisotropy are set as the long edge direction of the substrate, both the liquid crystal alignment capability has been applied to the alignment film, and at the same time, the monoaxial absorption anisotropy has been applied to the overcoat layer by employing the alignment film to which the liquid crystal alignment capability is applied by the linearly-polarized ultraviolet rays. As to the photosensitive resin of epoxy acrylate series having the fluorene skeleton, which is employed in this second embodiment, the following fact could be confirmed.

That is, this photosensitive resin produces the anisotropy by irradiating thereto the polarized ultraviolet rays and by performing the heating process operation just after the irradiation of the polarized ultraviolet rays. After the above-explained process operation, if the color filter substrate is arranged between the orthogonal polarizing plates and this color filter substrate is rotated, then the strength of the transmitted light is changed. In such a case that the polarization plane of the polarized ultraviolet rays which have been irradiated is located at the angle of 45 degrees with respect to the orthogonal polarizing plate, the strength of the transmitted light becomes maximum. In other words, in this second embodiment, the overcoat layer 26 and the anisotropic layer 41, shown in FIG. 5, have been formed as the same layer. Also, the difference between the strength of the transmitted light obtained in the case that the anisotropic axis of the color filter substrate is arranged perpendicular to the polarization axis of one sheet of the polarizing plate, and the strength of the transmitted light obtained in the case that the anisotropic axis of the color filter substrate is arranged in parallel with the polarization axis of one sheet of the polarizing plate was 4% in 450 nm, 2% in 544 nm, and 1% in 614 nm.

Next, two sheets of these substrates were arranged in such a manner that the surfaces thereof having alignment films 22 and 23 were located opposite to each other, and a sealing agent was coated on peripheral portions, so that a liquid crystal display panel was assembled which will constitute a liquid crystal display apparatus. These alignment films 22 and 23 own liquid crystal alignment capabilities. A nematic liquid crystal composition was injected into this liquid crystal display panel under vacuum condition, and then the resultant liquid crystal display panel was sealed by such a sealing member made of an ultraviolet ray hardening type resin. As to the above-explained nematic liquid crystal composition, dielectric constant anisotropy thereof is positive; a value thereof is 4.0 (1 KHz, 2020 C.); and refractive index anisotropy thereof is 0.10 (wavelength=590 nm, 20° C.). It should also be noted that such a material may be alternatively employed in this second embodiment, in which the dielectric constant anisotropy of the liquid crystal is negative. In this alternative case, the pixel electrode 105 may be formed in such a manner that the electric field may be inclined with respect to the horizontal direction at an angle of 45 degrees, or higher than 45 degrees.

Two sheets of polarizing plates 13 and 14 were adhered onto this liquid crystal display panel. While a transmission axis of the polarizing plate 13 was set to the long edge direction (scanning electrode direction) of the liquid crystal display panel, the polarizing plate 14 was arranged along a direction perpendicular to this transmission axis. It should be understood that as the polarizing plates 13 and 14, a viewing angle compensating polarizing plate was employed which is provided with a birefringent film capable of compensating a viewing angle characteristic of a wavelength dispersion owned by refractive index anisotropy of a polarizing plate and a liquid crystal material. Thereafter, a drive circuit, a back light unit, and the like are connected to the above-described liquid crystal display device so as- to construct a liquid crystal display module, so that a liquid crystal display apparatus is accomplished.

Subsequently, when display qualities of this liquid crystal display apparatus were evaluated, it can be confirmed that a contrast ratio is higher than, or equal to 700 over the substantially entire plane of the substrate, a chromaticity difference Δu′ v′ of both the black representation and the white representation is 0.055, and thus, better display qualities can be obtained.

### COMPARISON EXAMPLE 2

In this comparison example 2, the same structure as that of the embodiment 2 was manufactured except that the below-mentioned alignment film 23 was employed. That is, polyamic acid varnish was printed/formed, and then, was thermal-processed at a temperature of 230° C. for 10 minutes so as to form the alignment film 23. This alignment film 23 was made of the close polyimide film having the thickness of approximately 100 nm, and thereafter, was rubbing-processed. As a consequence, the polarized ultraviolet ray irradiating process operation to the color filter substrate employed in the second embodiment is not carried out, so that the color filter substrate does not own the monoaxial absorption anisotropy. In this liquid crystal display apparatus as the comparison example 2, it could be confirmed that a contrast ratio is 610, and a chromaticity difference Δu′ v′ of both the black representation and the white representation is 0.092.

### Embodiment 3

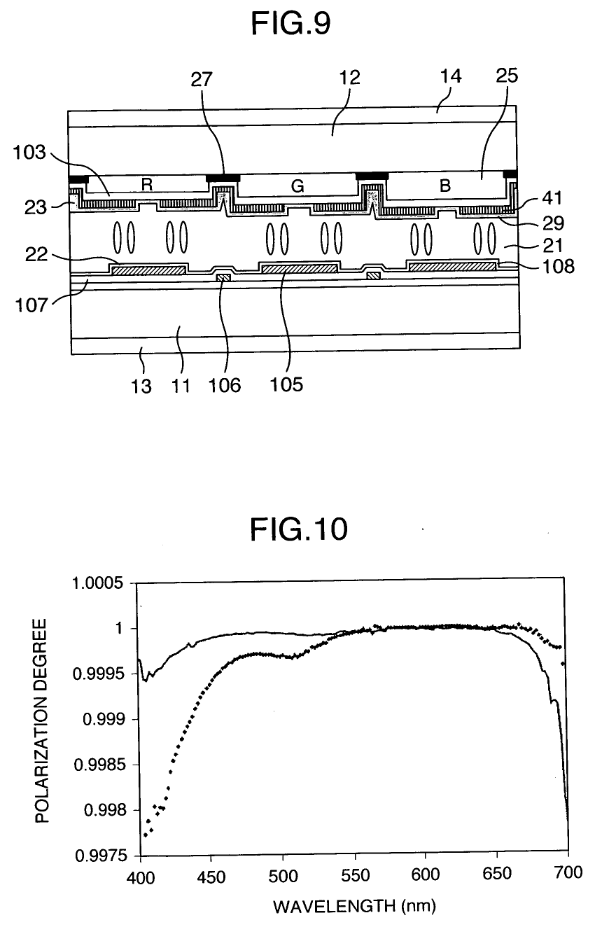

In this third embodiment, a monoaxial absorption anisotropic layer 41 has been formed on a color filter substrate of a vertical alignment mode (PVA) type liquid crystal display device indicated in FIG. 9.

As to the color filter substrate, chromium having a thickness of 160 nm and a chromium oxide film having a thickness of 40 nm were formed by way of a continuous sputtering method on a non-alkali glass substrate 12 having a thickness of 0.7 mm, and then, a positive type resist was processed through various steps, namely, a coating step, a pre-baking step, an exposing step, a developing step, an etching step, a stripping step, and a cleaning step. Next, while the respective color resists made by Fuji Film Arch Company were employed, a color filter was formed by performing a photolithography method (namely, standard processing method) through various steps, namely, a coating step, a pre-baking step, an exposing step, a developing step, a rinsing step, and a post-baking step. Although film thicknesses as to a B pixel, a G pixel, and an R pixel were selected to be 3.0 μm, 2,8 μm, 2.7 μm, respectively in this third embodiment, these film thicknesses may be properly matched with respect to a desirable color purity, or a desirable liquid crystal layer thickness.

Next, Direct Orange 39 was added to V-259 made by Shin Nittetsu Kagaku company by 2 weight percents, and then, an overcoat layer was formed by employing the resultant Direct Orange 39. In the exposing step, light having an amount of 200 mJ/cm² was irradiated onto the overcoat layer by way of i-rays of a high pressure mercury vapor lamp, and thereafter, the overcoat layer was formed by heating the overcoat layer for 30 minutes at a temperature of 230° C. A film thickness of the overcoat layer was approximately 1.2 to 1.5 μm on color pixels.

Next, an ITO film having a thickness of 140 nm was vapor-deposited under vacuum condition by way of a sputtering method, and the vapor-deposited ITO film was heated for 90 minutes at a temperature of 240° C. so as to be crystallized, and then, a pattern of a common electrode 103 was formed by performing a photographic step and an etching process operation. An opening portion of the common electrode 103 sandwiches an opening portion of a pixel electrode 105 at an intermediate portion thereof. Next, a pillar-shaped spacer was formed at a height of approximately 3.8 μm on such a black matrix sandwiched by B pixels by performing both a photolithography method and an etching process (namely, standard processing methods), while a photosensitive resin was employed.

Next, while a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was substantially vertically irradiated onto the substrate in irradiation energy of approximately 1 J/cm², while heating the substrate at a temperature of 230° C. A polarization direction of the irradiated polarized light was selected to be coincident with a short edge direction (for example, signal electrode direction in TFT substrate) of the substrate. An absorption axis of the anisotropic layer 41 is formed along a direction perpendicular to a transmission axis of a light projection-sided polarizing plate 14. In this third embodiment, the transmission axis of the light projection-sided polarizing plate 14 corresponds to a short edge direction of the substrate (namely, same direction as the signal electrode 106), and an absorption axial direction corresponds to a long edge direct of the substrate (namely, direction of scanning electrode 104, not shown). When an axial arrangement of a polarizing plate is changed, a transmission axis and an absorption axis may be determined so as to be matched with this changed axial arrangement.

A scanning electrode (gate electrode) 104 (not shown in the drawing) made of Mo/Al (molybdenium/aluminium) was formed on a substrate 11 which is made of non-alkali glass and has a thickness of 0.7 mm as an active matrix substrate. Alternatively, a storage capacity electrode (not shown) may be formed in the same layer by employing chromium, or aluminium. While a gate insulating film 107 was formed in order to cover these structural elements, both a signal electrode (drain electrode) 106 and a thin-film transistor (not shown) were formed in a similar manner to that of the first embodiment. While a protection insulating film 108 was formed in order to cover these structural elements, a pixel electrode 105 having an opening pattern was formed on this protection insulating film 108 by employing ITO. Alternatively, such a transparent conductive member as ITO may be employed. Active matrix substrates having a total number of pixels of 1024×3×768 pieces was manufactured which is constituted by 1024×3 (corresponding to R, G, B pixels) pieces of the signal electrodes 106, and also, 768 pieces of the scanning electrodes 104.

An alignment film 22 and another alignment film 23, which are vertically aligned, were formed on the TFT substrate and the color filter substrate, respectively. While a sealing agent was coated on a peripheral portion of the substrates, such a liquid crystal material having negative dielectric anisotropy was filled in a droplet manner by the ODF method, so that a liquid crystal display panel was assembled. As previously explained, the polarizing plates 13 and 14 have been arranged. That is, the transmission axis of the light incident-sided polarizing plate 13 was set as the long edge direction of the substrate, and the transmission axis of the light projection-sided polarizing plate 14 was set as the short edge direction of the substrate, and also, these transmission axes were intersected with each other at a right angle. As the polarizing plates 13 and 14, a viewing angle compensating polarizing plate was employed which is provided with a birefringent film capable of compensating a viewing angle characteristic. Thereafter, a drive circuit, a back light unit, and the like are connected to the above-described liquid crystal display device so as to construct a liquid crystal display module, so that a liquid crystal display apparatus is accomplished.

Subsequently, when display qualities of this liquid crystal display apparatus were evaluated, it can be confirmed that a contrast ratio is higher than, or equal to 700 over the substantially entire plane of the substrates, a chromaticity difference Δu′ v′ of both the black representation and the white representation is 0.042, and thus, better display qualities can be obtained.

It should also be understood that in this third embodiment, the PVA mode type liquid crystal display apparatus has been employed with employment of the notched pattern of ITO. In the case of an MVA type liquid crystal display apparatus in which a projection is provided on a color filter substrate, after an ITO film has been formed, a manufacturing step is advanced to a step for forming a pillar-shaped spacer via a projection forming process. An anisotropic layer may be formed in a similar manner to that of this third embodiment.

### Embodiment 4

As to a color filter substrate, while a high optical density black resist made by Tokyo Ohka Kogyo (K.K) was employed, a black matrix was formed on the substrate 12 by executing a photolithography method (namely, standard processing method) through various steps, namely, a coating step, a pre-baking step, an exposing step, a developing step, a rising step, and a post-baking step. It should be understood that the film thickness was selected to be 1.0 μm, and the optical density was nearly equal to 3.8. Next, while a dye resist manufactured by Shumitomo Kagaku Company was employed which had no adverse influence of a scattering phenomenon by pigment particles, Direct Orange 39 was mixed with a blue resist by 5 weight percents; Direct Red 81 was mixed with a green resist by 3 weight percents; and Direct Blue 90 was mixed with a red resist by 2 weight percents; and then, a color filter was formed by performing a photolithography method (namely, standard processing method) through various steps, namely, a coating step, a pre-baking step, an exposing step, a developing step, a rinsing step, and a post-baking step. The film thicknesses as to a B pixel, a G pixel, and an R pixel were selected to be 1.7 μm, 1.5 μm, 1.5 μm, respectively in this fourth embodiment. A shape of the black matrix is made similar to that of the above-described embodiment 2 shown in FIG. 8. While a coloring matter added to the resists owns a high linear rod-shaped molecular structure of monoaxial absorption anisotropy, a transmission axis (absorption axis is orthogonal direction) can be formed along an axial direction of irradiated linearly polarized light by irradiating the linearly-polarized light to the coloring matter. Since the maximum absorption wavelength of Direct Red 81 added to the green resist corresponds to 540 nm and the maximum absorption wavelength of Direct Blue 90 added to the red resist corresponds to 600 nm, such a polarized light obtained by linearly polarizing argon ion laser light by a pile polarizer was irradiated by an amount of 6 J/cm² at a temperature of 200° C., and both a green filter and a red filter were formed as a monoaxial absorption layer.

Next, in order to obtain a flatness and protect the color filter layer, an overcoat layer was formed by employing V-259 manufactured by Shin Nittetsu Kagaku company. In an exposing step, light having an amount of 200 mJ/cm² was irradiated onto the overcoat layer by way of i-rays of a high pressure mercury vapor lamp, and thereafter, the overcoat layer was formed by heating the overcoat layer for 30 minutes at a temperature of 200° C. A film thickness of the overcoat layer was approximately 1.2 to 1.5 μm on color pixels. Next, a pillar-shaped spacer was formed at a height of approximately 3.8μm on such a black matrix sandwiched by B pixels by performing both a photolithography method and an etching process (namely, standard processing method), while a photosensitive resin was employed. It should also be noted that the position of the pillar-shaped spacer is not limited only to the above-explained position of this fourth embodiment, but may be arbitrarily set, if required.

An active matrix substrate of this fourth embodiment was made similar to that of the second embodiment. As to alignment films used for both the color filter substrate and the active matrix substrate, such a polyimide alignment film having a cyclobutane skeleton was employed to which a liquid crystal alignment capability was applied by irradiating linearly-polarized ultraviolet rays. Next, polyamic acid varnish was printed/formed, while this polyamic acid varnish is made of such a varnish which is constituted by, as a monomer component, diamine made by mixing 4,4′-diamino azo benzen with 4,4′-diaminobenzophenon in a molar ratio of 6:4, and also, acid anhydride made by mixing pyromellitic acid 10 anhydride with 1,2,3,4-cyclobutane tetracarboxylic acid anhydride in a molar ratio of 1:1. This polyamic acid varnish was thermal-processed at a temperature of 210° C. for 10 minutes so as to form an alignment film 22. This alignment film 22 is made of a close polyimide film having a thickness of approximately 100 nm. Then, ultraviolet rays corresponding to linearly polarized light was irradiated along a direction substantially vertical to the substrate. It should also be understood that as to the alignment film 22 of this fourth embodiment, no specific limitation is made if such a material is used to which a liquid crystal alignment capability can be applied by linearly polarized ultraviolet rays along a direction perpendicular to a polarization plane.

While a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was irradiated onto the substrate in irradiation energy of approximately 7 J/cm², while heating the substrate at a temperature of 200° C. As a result, both the liquid crystal alignment capability and the monoaxial absorption anisotropy were applied to a blue filter layer of the color filter. In the structure of this fourth embodiment, the anisotrophic layer 41 shown in the schematic sectional view of FIG. was not formed, but anisotropy was applied to a colored layer 25. Since such a compound which indicates an absorption peak of dichroism in the vicinity of a strength of transmitted light of the color filter layer has been added with respect to each of those colors, the color filter substrate may own the monoaxial absorption anisotropy over the entire range of substantially visible light wavelengths.

Thereafter, a liquid crystal display apparatus according to the fourth embodiment could be obtained in a similar manner to that of the second embodiment. It should also the understood that such a polarizing plate having very high polarization degrees was employed, while a polarization degree corresponds to 0.99994 in the blue range (450 nm); a polarization degree corresponds to 0.99997 in the green range (550 nm); and a polarization degree corresponds to 0.99997 in the red range (620 nm).

Subsequently, when display qualities of this liquid crystal display apparatus were evaluated, it can be confirmed that a contrast ratio is very high, namely, higher than, or equal to 900 over the substantially entire plane of the substrate, a chromaticity difference Δu′ v′ of both the black representation and the white representation is 0.051, and thus, better display qualities can be obtained.

### Embodiment 5

A liquid crystal display apparatus according to a fifth embodiment of the present invention is manufactured in a similar manner to that of the fourth embodiment except that a dichroism coloring matter is not added to both a green resist and a red resist, but Direct Orange 39 has been added to a blue resist by 5 weight percents. When display qualities of the liquid crystal display apparatus of the fifth embodiment were evaluated, it can be confirmed that a contrast ratio is higher than, or equal to 800 over the substantially entire plane of the substrate, a chromaticity difference Δu′ v′ of both the black representation and the white representation is 0.041, and thus, better display qualities can be obtained.

### Embodiment 6

In a liquid crystal display apparatus according to a sixth embodiment, while the above-explained structure of the fourth embodiment was employed, the above-described polarizing plate of the fourth embodiment was substituted by such a polarizing plate having polarization degrees, namely, a polarization degree corresponds to 0.99907 in the blue range (450 nm); a polarization degree corresponds to 0.99983 in the green range (550 nm); and a polarization degree corresponds to 0.99990 in the red range (620 nm). Then, when display qualities of this liquid crystal display apparatus were evaluated, it can be confirmed that a contrast ratio is high, namely, higher than, or equal to 750, a chromaticity difference Δu′ v′ of both the black representation and the white representation is 0.058, and thus, better display qualities can be obtained, even when the polarizing plate having the low polarization degree was employed.

### COMPARISON EXAMPLE 3

As a comparison example 3, while a dye resist manufactured by Sumitomo Kagaku company was employed and an alignment film was made as a polyimide alignment film which had been rubbing-processed, such a liquid crystal display panel whose pixel structure is similar to that of the second embodiment was manufactured. In the case that the below-mentioned polarizing plate was adhered to this manufactured liquid crystal display panel, namely a polarization degree corresponds to 0.99994 in the blue range (450 nm); a polarization degree corresponds to 0.99997 in the green range (550 nm); and a polarization degree corresponds to 0.99997 in the red range (620 nm), it can be confirmed that a contrast ratio is equal to 800, and a chromaticity difference Δu′ v′ of both the black representation and the white representation is 0.095.

Next, when the above-explained polarizing plate of the comparison example 3 was replaced by such a polarizing plate that a polarization degree corresponds to 0.99907 in the blue range (450 nm), a polarization degree corresponds to 0.99983 in the green range (550 nm); and a polarization degree corresponds to 0.99990 in the red range (620 nm), it can be confirmed that a contrast ratio is equal to 620, and a chromaticity difference Δu′ v′ of both the black representation and the white representation is 0.12.

### Embodiment 7

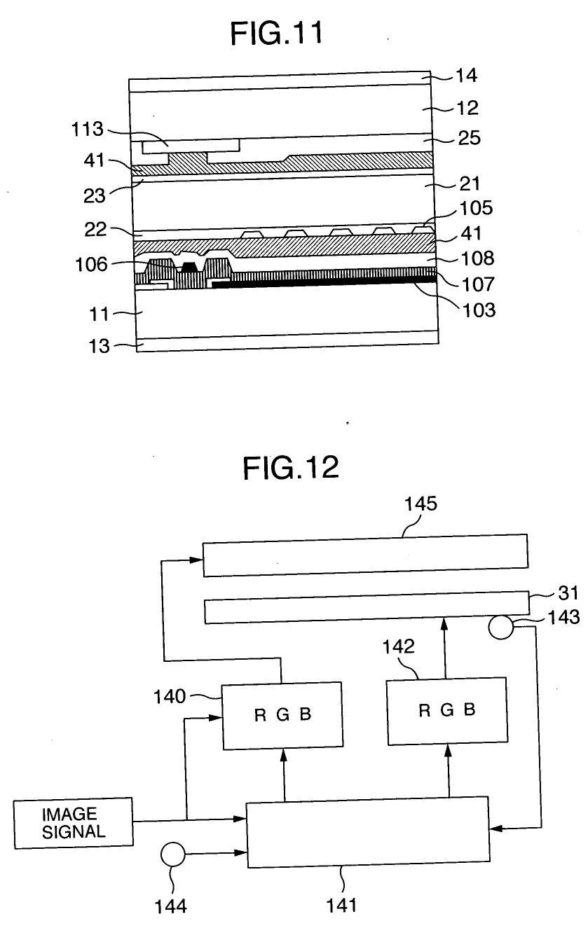

FIG. 11 is a sectional view for schematically representing an area in the vicinity of one pixel, which explains an embodiment mode 7 of a liquid crystal display according to the present invention. It should be understood that structurals such as electrodes of this liquid crystal display apparatus of the seventh embodiment are made substantially identical to those of the above-explained second embodiment. That is, in this seventh embodiment, a transparent acrylic-series resin layer (indicated by reference numeral 41 of FIG. 11) having a thickness of 1.0 μm was formed on a protection insulating film 108 of an active matrix substrate. Similar to the second embodiment, after a pixel electrode 105 has been formed, a polyamic acid varnish was printed/formed. This polyamic acid varnish was thermal-processed at a temperature of 230° C. for 10 minutes so as to form an alignment film 22. This alignment film 22 is made of a close polyimide film having a thickness of approximately 100 nm. Then, ultraviolet rays corresponding to linearly polarized light was irradiated along a direction substantially vertical to the substrate. While a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was irradiated onto the substrate in irradiation energy of approximately 7 J/cm², while heating the substrate at a temperature of 230° C. In this seventh embodiment, an initial alignment condition of liquid crystal, namely an alignment direction when no voltage is applied to the liquid crystal may constitute the direction of the scanning electrode 104 shown in FIG. 7, namely, the horizontal direction of this drawing. As a consequence, a polarization plane to which the ultraviolet rays are irradiated corresponds to the short edge side of the substrate, namely, the direction of the signal electrode 106 of FIG. 7. Since the polarized ultraviolet rays having the high energy is irradiated to the acrylic-series resin, optical oxidation is progressed, and further, since this acrylic-series resin is irradiated in the high temperature, the absorption wavelengths are amplified from the ultraviolet range up to the visible light wavelength. As a result, such an absorption is represented in such a short wavelength range shorter than, or equal to 480 nm along a direction parallel to the irradiated polarization plane. In this seventh embodiment, since the polarization plane to be irradiated corresponds to the short edge direction (namely, direction of signal 15 electrode 106 of FIG. 7) of the substrate, such an anisotropic layer 41 indicative of an absorption along this short edge direction is formed on the active matrix substrate. Similar to the second embodiment, the liquid crystal alignment capability is applied to the alignment film along the longer edge direction (namely, direction of scanning electrode 104 of FIG. 7) of the substrate. The transmission axis of the light incident-sided polarizing plate 13 is assumed to be equal to the long edge direction of the substrate. As a result, the absorption axis of the light incident-sided polarizing plate 13 becomes parallel to the absorption axis of the anisotropic layer 41 on the active matrix substrate. As a consequence, the anisotropic layer 41 formed on the active matrix substrate may compensate the polarization degree of the polarizing plate 13 in the short wavelength range. Also, the difference between the strength of the transmitted light obtained in the case that the anisotropic axis of the active matrix substrate of this seventh embodiment is arranged perpendicular to the polarization axis of one sheet of the polarizing plate, and the strength of the transmitted light obtained in the case that the anisotropic axis of this active matrix substrate is arranged in parallel with the polarization axis of one sheet of the polarizing plate was 7% in 450 nm.

In the seventh embodiment, a color filter substrate was made similar to that of the second embodiment. In other words, the anisotropic layer formed on the color filter substrate may commonly function as an overcoat layer. Also, since the absorption axis of the anisotropic layer 41 formed on the color filter substrate is directed to the same direction with respect to the absorption axis of the light projection-sided polarizing plate 14, the anisotropic layers 41 which have been formed on the respective substrates (namely, active matrix substrate and color filter substrate) can largely improve the polarization degrees of the polarizing plates 13 and 14. More specifically, the isotropic layers 41 can compensate lowering of the polarization degree in the short wavelength range.

In this seventh embodiment, a liquid crystal display panel was assembled in a similar manner to that of the second embodiment, so that a liquid crystal display apparatus was obtained. As to the polarizing plates employed in this seventh embodiment, a polarization degree corresponds to 0.99994 in the blue range (450 nm); a polarization degree corresponds to 0.99997 in the green range (550 nm); and a polarization degree corresponds to 0.99997 in the red range (620 nm). Then, when display qualities of this liquid crystal display apparatus were evaluated, it can be confirmed that a contrast ratio is higher than, or equal to 780 over the substantially entire plane of the substrate, a chromaticity difference Δu′ v′ of both the black representation and the white representation is 0.040, and thus, better display qualities can be obtained.

### Embodiment 8

A liquid crystal display apparatus according to an eighth embodiment of the present invention was manufactured in such a manner that while the liquid crystal display panel of the seventh embodiment was employed, the polarizing plate thereof was replaced by such a polarizing plate having such deteriorated polarization degrees that a polarization degree corresponds to 0.99692 in the blue range (450 nm); a polarization degree corresponds to 0.99973 in the green range (550 nm); and a polarization degree corresponds to 0.99981 in the red range (620 nm). Then, when display qualities of this liquid crystal display apparatus were evaluated, it can be confirmed that a contrast ratio is maintained higher than, or equal to 700 over the substantially entire plane of the substrate. Also, as to the polarizing plates employed in this eighth embodiment, the polarization degree in the blue range is considerably lowered, and the contrast ratio thereof is slightly 330. However, since both the active matrix substrate and the color filter substrate own the functions capable of compensating the polarization degree of the blue range, it can be confirmed that a chromaticity difference Δu′ v′ of both the black representation and the white representation is 0.068, and since the structure of the seventh embodiment is employed, a margin with respect to the polarization degrees of the polarizing plates to be employed may be enlarged.

### Embodiment 9

A liquid crystal display apparatus according to a ninth embodiment has been arranged as follows: That is, the structure of the liquid crystal display panel explained in the above-described second embodiment is combined with a light source unit, while a light source is arranged by RGB light emitting diodes. The light source unit simultaneously controls changes of display data every color of the liquid crystal display panel and a light emitting amount of the light source unit every color based upon an output signal derived from an optical sensor for sensing a light emission of the light source, an image signal which has been entered into the liquid crystal display panel so as to display an image thereon, and an output signal derived from an external light sensor for sensing an external environmental light.

FIG. 12 is a schematic block diagram for showing the arrangement of the liquid crystal display apparatus according to the ninth embodiment. This liquid crystal display apparatus is arranged by a controller 141, a display data changing circuit 140, a light source light amount control circuit 142, a liquid crystal display panel 145, a light source unit 31, a light source light sensor 143, and an external light sensor 144. In this ninth embodiment, the structure of the liquid crystal display panel 145 is made similar to that of the above-described eighth embodiment. The controller 141 determines an amount for changing an entered image signal, and at the same time, determines a light amount of the light source based upon an image signal which is entered from a personal computer, or a TV tuner, and a sensor signal outputted from the external light sensor 144 which senses a lightening condition of an external environment, and also, signals derived from the light source light sensor 143 which measures strengths of R(red), G(green), B(blue) light emissions by the light source unit 31.

The display data changing circuit 140 contains therein data converting circuits with respect to the blue display data, the green display data, and the red display data. The display data changing circuit 140 converts the entered image signal every color in response to the control signal outputted from the controller 141, and then, outputs the converted image data to the liquid crystal display panel 145. Also, the light source light amount control circuit 142 contains therein a blue light emission control circuit, a green light emission control circuit, and a red light emission control circuit. This light source light amount control circuit 142 controls the light emission of the light source unit 31 every color in response to the control signal from the controller 141.

Since the light source and the circuit for executing the image control operation are provided as shown in FIG. 12, the display dynamic range in the liquid crystal display apparatus can be widened. More specifically, the structure of the liquid crystal display panel capable of improving the black representation performance, according to this ninth embodiment, is employed, so that the dynamic range of the display operation can be considerably enlarged. Also, since the high contrast ratio with respect to the light representation and the dark representation adjacent to the light representation on the same screen can be maintained, such a liquid crystal display apparatus having the high display quality can be realized. Furthermore, in such a liquid crystal display apparatus in which a light source is segmented into a plurality of areas and light amounts are controlled in a more precise manner, a higher contrast ratio can be maintained on such a display screen that, for example, fireworks in the night sky are displayed.

### Embodiment 10

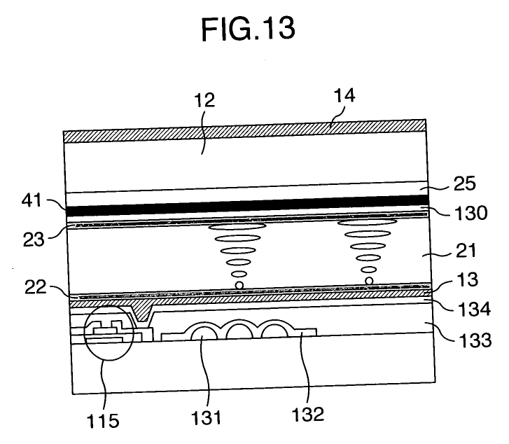

In an embodiment 10, a partial transmission type liquid crystal display apparatus which contains a reflection portion and a transmission portion within 1 pixel was manufactured. As indicated in FIG. 13, a substrate 11 having a thickness of 0.5 mm corresponds to an active matrix substrate, and a thin-film transistor 115 has been connected to a scanning wiring line, a signal wiring line, and a transparent electrode 134. A reflection display portion corresponds to an upper portion of a reflection film 132 which has been formed in such a manner that a concave/convex layer 131 is covered, on which a flattening layer 133 made of an acrylic resin is formed. After a surface of the flattening layer 133 has been rubbed, a polarizing plate 13 is formed. The polarizing plate 13 was formed by way of a photolithography method in such a manner that Direct Blue 202, Direct Orange 39, and Direct red 81 were mixed with a photosensitive resin in a ratio of 7:1:2, which contains an epoxy acrylate derivative having a fluorene skeleton; and then, the mixed photosensitive resin is coated by a bar coater. An alignment film 22 was formed by an optical reactive polyimide alignment film having a cyclobutane skeleton, and then, ultraviolet rays corresponding to linearly polarized light was irradiated along a direction substantially vertical to the substrate. While a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was irradiated onto the substrate in irradiation energy of approximately 7 J/cm², while heating the substrate at a temperature of 230° C. As a consequence, the liquid crystal alignment capability was given to the alignment film 22, and the monoaxial anisotropic characteristic was given to the polarizing plate 13 so as to apply the polarization capability.

A substrate 12 was formed in such a manner that after a black matrix had been formed by a black resist and a colored layer 25 has been formed by a color resist, an overcoat layer was formed by a photosensitive resin in which Direct Yellow 44 was added by 2 weight percents to an epoxy acrylate-series resin having a fluorene skeleton. Next, an alignment film 23 was formed by an optical reactive polyimide alignment film having a cyclobutane skeleton, and then, ultraviolet rays corresponding to linearly polarized light was irradiated along a direction substantially vertical to the substrate. While a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was irradiated onto the substrate in irradiation energy of approximately 5 J/cm², while heating the substrate at a temperature of 230° C. As a result, the liquid crystal alignment capability was given to the alignment film 23, whereas such a monaxial absorption anisotropy having an absorption maximal value in the wavelength of 420 nm was applied to the anisotropic layer 41 also having the function of the overcoat layer. Then, spacer beads each having a diameter of 5 μm were distributed, and a liquid crystal display panel was assembled in such a manner that the alignment films were located opposite to each other, and thereafter, nematic liquid crystal was injected into this liquid crystal display panel under vacuum condition. As to the above-explained nematic liquid crystal, dielectric constant anisotropy thereof is positive; and refractive index anisotropy thereof is 0.071 (wavelength=589 nm, 20° C.). The light project-sided polarizing plate 14 was adhered to the upper plane of the substrate 12, and thereafter, a drive circuit, a back light unit, and the like are connected to the above-described liquid crystal display device so as to construct a liquid crystal display module, so that a liquid crystal display apparatus was accomplished. Since one sheet of the polarizing plate is contained in the liquid crystal display apparatus, the slim apparatus can be obtained. Furthermore, while the contrast ratio of the transmission display area is 100, and the contrast ratio of the reflection display area is 25 such a semitransmission type liquid crystal display apparatus could be obtained, the image quality of which was better in a mobile use field. Although the polarization degree of the polarizing plate 13 is lower than that of the normally used polarizing plate, the above-explained display image quality could be obtained by the anisotropic layer 41 which was formed by being irradiated by the polarized ultraviolet ryas.

It should also be understood that the coating type polarizing plate may be alternatively constituted by employing a flat-plate type coloring matter such as an anthraquinone series, a phthalocyassine series, a porphyrin series, a naphtharocyanine series a quinacridon series, a dioxazine series, an indanthrene series, an acridine series, a perylene series, a pyrazolone series, an acridone series, a pyranthrone series, an iso-violanthrone series, and the like. Although the flattening layer has been rubbing-processed and thereafter, the polarizing plate is coated in this tenth embodiment, such a polarizing plate may be alternatively employed which contains a proper surface-active agent and is formed by a coating process. If contrast ratios of these coating type polarizing plates are larger than, or equal to 1000, then a liquid crystal display apparatus may be arranged not only in a mobile use field, but also as a liquid crystal television receiver by combining these coating type polarizing plate with the anisotropic layer built-in type liquid crystal display panel of the present invention. In this alternative case, tri-acetyliellulose may be omitted which is employed as the protection layer of the polarizing plate, so that a slim liquid crystal display apparatus having an improved viewing angle characterisitc of the polarizing plate may be accomplished.

### Embodiment 11

FIG. 11 is a sectional view for schematically representing an area in the vicinity of one pixel, which explains an embodiment mode 11 of a liquid crystal display according to the present invention. It should be understood that structurals such as electrodes of this liquid crystal display apparatus of the 11-th embodiment are made substantially identical to those of the above-explained second embodiment. That is, in this seventh embodiment, a transparent acrylic-series resin layer (indicated by reference numeral 41 of FIG. 11) having a thickness of 1.0 μm was formed on a protection insulating film 108 of an active matrix substrate. Similar to the second embodiment, after a pixel electrode 105 has been formed, a polyamic acid varnish was printed/formed. This polyamic acid varnish was thermal-processed at a temperature of 230° C. for 10 minutes so as to form an alignment film 22. This alignment film 22 is made of a close polyimide film having a thickness of approximately 100 nm. Then, ultraviolet rays corresponding to linearly polarized light was irradiated along a direction substantially vertical to the substrate. While a high pressure mercury vapor lamp was used as a light source, ultraviolet rays in a wavelength range from 200 to 400 nm were derived from this lamp via an interference filter, the derived ultraviolet rays were changed into linearly polarized light having a polarization ratio of approximately 10:1 by using a pile polarizer in which quartz substrates were stacked with each other, and then, the linearly polarized light was irradiated onto the substrate in irradiation energy of approximately 7 J/cm², while heating the substrate at a temperature of 230° C. In this 11-th embodiment, an initial alignment condition of liquid crystal, namely an alignment direction when no voltage is applied to the liquid crystal may constitute the direction of the scanning electrode 104 shown in FIG. 7, namely, the horizontal direction of this drawing. As a consequence, a polarization plane to which the ultraviolet rays are irradiated corresponds to the short edge side of the substrate, namely, the direction of the signal electrode 106 of FIG. 7. Since the polarized ultraviolet rays having the high energy is irradiated to the acrylic-series resin, optical oxidation is progressed, and further, since this acrylic-series resin is irradiated in the high temperature, the absorption wavelengths are amplified from the ultraviolet range up to the visible light wavelength. As a result, such an absorption is represented in such a short wavelength range shorter than, or equal to 480 nm along a direction parallel to the irradiated polarization plane. In this seventh embodiment, since the polarization plane to be irradiated corresponds to the short edge direction (namely, direction of signal electrode 106 of FIG. 7) of the substrate, such an anisotropic layer 41 indicative of an absorption along this short edge direction is formed on the active matrix substrate. Similar to the second embodiment, the liquid crystal alignment capability is applied to the alignment film along the longer edge direction (namely, direction of scanning electrode 104 of FIG. 7) of the substrate. The transmission axis of the light incident-sided polarizing plate 13 is assumed to be equal to the long edge direction of the substrate. As a result, the absorption axis of the light incident-sided polarizing plate 13 becomes parallel to the absorption axis of the anisotropic layer 41 on the active matrix substrate. As a consequence, the anisotropic layer 41 formed on the active matrix substrate may compensate the polarization degree of the polarizing plate 13 in the short wavelength range. 10 Also, the difference between the strength of the transmitted light obtained in the case that the anisotropic axis of the active matrix substrate of this polarization axis of one sheet of the polarizing plate, and the strength of the transmitted light obtained in the case that the anisotropic axis of this active matrix substrate is arranged in parallel with the polarization axis of one sheet of the polarizing plate was 7% in 450 nm.

In the 11-th embodiment, a color filter substrate was made similar to that of the second embodiment. In other words, the anisotropic layer formed on the color filter substrate may commonly function as an overcoat layer. In this 11-th embodiment, both the liquid crystal alignment capability has been applied to the alignment film, and at the same time, the monoaxial absorption anisotropy has been applied to the overcoat layer by employing the alignment film to which the liquid crystal alignment capability is applied by the linearly-polarized ultraviolet rays. As to the photosensitive resin of epoxy acrylate series having the fluorene skeleton, which is employed in this 11-th embodiment, this photosensitive resin produces the anisotropy by irradiating thereto the polarized ultraviolet rays and by performing the heating process operation just after the irradiation of the polarized ultraviolet rays. Also, the difference between the strength of the transmitted light obtained in the case that the anisotropic axis of the color filter substrate is arranged perpendicular to the polarization axis of one sheet of the polarizing plate, and the strength of the transmitted light obtained in the case that the anisotropic axis of the color filter substrate is arranged in parallel with the polarization axis of one sheet of the polarizing plate was 4% in 450 nm, 2% in 544 nm, and 1% in 614 nm.

In this 11-th embodiment, a liquid crystal display panel was assembled in a similar manner to that of the second embodiment, so that a liquid crystal display apparatus was obtained. As to the polarizing plates employed in this 11-th embodiment, a polarization degree corresponds to 0.99692 in the blue range (450 nm); a polarization degree corresponds to 0.99973 in the green range (550 nm); and a polarization degree corresponds to 0.99981 in the red range (620 nm). However, in the structure of the liquid crystal display apparatus according to this 11-th embodiment, since the monoaxial absorption anisotropic layer formed in the liquid crystal display panel may have such a function capable of aiding the polarization degree of the polarizing plate, it is possible to achieve such a display performance which is in no way inferior to the display performance achieved in the case that a polarizing plate whose polarization degree is on the order of 0.9999 is employed.

It should also be understood that since both the resin and the dichroism coloring matter are furthermore optimized which have been employed as the monoaxial absorption anisotropic layer, the polarization degree compensating function may be furthermore improved. As to a polarizing plate employed in this alternative case, such a polarizing plate formed by way of either a coating system or a printing system may be applied to such a liquid crystal display apparatus as a liquid crystal television receiver, the high image quality of which is required, while the polarization degree of this polarizing plate is lower than that of an iodine type polarizer which is normally employed. If the polarizing plate formed by way of the coating system, or the printing system is employed, then such a structure capable of omitting a protection layer made of tri-acetylicellulose etc. may be made, and a viewing angle characteristic of this polarizing plate may become better. As a consequence, a phase difference layer for compensating a viewing angle may be easily designed, and there is a merit as to a wide viewing angle.

In the liquid crystal display panel of this 11-th embodiment, both an optical source unit and a control circuit were employed which are similar to those of the ninth embodiment. Even when the polarizing plate whose polarization degree becomes inferior is employed, since the polarization degree has been compensated as the liquid crystal display panel, and since the high contrast ratio with respect to the light representation and the dark representation adjacent to the light representation on the same screen can be maintained, such a liquid crystal display apparatus having the high display quality can be realized. Furthermore, in such a liquid crystal display apparatus in which a light source is segmented into a plurality of areas and light amounts are controlled in a more precise manner, a higher contrast ratio can be maintained on such a display screen that, for example, fireworks in the night sky are displayed.

Also, the liquid crystal display apparatus in which the auxiliary polarizing plate function has been added to the substrate of the liquid crystal display panel is combined with, for instance, a light source for representing polarized light with employment of a light emitting diode and a waveguide, or another light source with employment of an organic EL for emitting polarized light, so that such a liquid crystal display apparatus capable of considerably improving an efficiency may be alternatively realized. Since such a light source unit having polarized light is employed, in accordance with the present invention, there is an effect capable of suppressing that since an adverse influence caused by fluctuations of the polarizing plate becomes large, a margin of production is reduced.

As previously described in detail, the liquid crystal display apparatus according to the present invention may be widely utilized.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display apparatus comprising:
one pair of substrates;
one pair of polarizing plates which are arranged on said one pair of substrates respectively;
a liquid crystal layer which is sandwiched by said one pair of substrates;
an electrode group which is formed on at least one of said one pair of substrates and is to apply an electric field to said liquid crystal layer; and
a light source which is arranged outside said one pair of substrates; wherein:
a layer having monoaxial absorption anisotropy is provided between said one pair of polarizing plates, while said layer owns an absorption axis along one direction and light is transmitted through said layer along the other direction.

2. A liquid crystal display apparatus according to claim 1, further comprising an alignment film which is arranged on each of said paired substrates, and said alignment film being made of a material capable of applying an alignment control function by applying thereto light which has been substantially linearly polarized.

3. A liquid crystal display apparatus according to claim 1 wherein:
said layer having the monoaxial absorption anisotropy owns a material which indicates the monoaxial absorption anisotropy by irrating thereto light which has been substantially linearly polarized.

4. A liquid crystal display apparatus comprising:
one pair of substrates;
one pair of polarizing plates which are arranged on said one pair of substrates respectively;
a liquid crystal layer which is sandwiched by said one pair of substrates;
an electrode group which is formed on at least one of said one pair of substrates and is to apply an electric field to said liquid crystal layer; and
a light source which is arranged outside said one pair of substrates; wherein:
at least one of said paired substrates owns monoaxial absorption isotropy.

5. A liquid crystal display apparatus according to claim 1 wherein:
said layer having said monoaxial absorption anisotropy owns a function capable of protecting a colored layer.

6. A liquid crystal display apparatus according to claim 1 wherein:
said layer having said monoaxial absorption anisotropy corresponds to at least one color filter of a colored layer.

7. A liquid crystal display apparatus according to claim 1 wherein:
said layer having said monoaxial absorption anisotropy corresponds to an insulating layer formed on an active matrix substrate.

8. A liquid crystal display apparatus according to claim 1 wherein:
monoaxial absorption anisotropy in a short wavelength range shorter than, equal to 500 nm is stronger than monoaxial absorption anisotropy in a long wavelength range longer than 500 nm.

9. A liquid crystal display apparatus according to claim 4 wherein:
one of said paired substrates corresponds to an active matrix substrate where said electrode group has been formed; and the other substrate located opposite to said active matrix substrate owns monoaxial absorption anisotropy.

10. A liquid crystal display apparatus according to claim 4 wherein:
one of said paired substrates corresponds to an active matrix substrate where sid electrode group has been formed; and said active matrix substrate owns monoaxial absorption anisotropy.

11. A liquid crystal display apparatus according to claim 5 wherein:
said layer having the monoaxial absorption anisotropy includes an epoxy acrylate series of resin having a fluorene skeleton.

12. A liquid crystal display apparatus according to claim 7 wherein:
said layer having the monoaxial absorption anisotropy includes a resin of acrylic-series polymer.

13. A liquid crystal display apparatus according to claim 1 wherein:
the absorption axis of said layer having the monoaxial absorption anisotropy runs substantially parallel to an absorption axis of any one of said paired polarizing plates.

14. A liquid crystal display apparatus according to claim 1 wherein:
the layer having the monoaxial absorption anisotropy is formed on the substrate located on the side of an observer within said paired substrates; and the absorption axis of said layer runs substantially parallel to an absorption axis of the polarizing plate which is provided on the side of the observer of said liquid crystal display panel.

15. A liquid crystal display apparatus according to claim 1 wherein:
the layer having the monoaxial absorption anisotropy is formed on the substrate located on the side of the light source within said paired substrates;
and the absorption axis of said layer runs substantially parallel to an absorption axis of the polarizing plate which is provided on the side of the light source of said liquid crystal display panel.

16. A liquid crystal display apparatus according to claim 1 wherein:
a long axial direction of a liquid crystal molecule which constitutes said liquid crystal layer on an alignment control film formed on said paired substrates runs substantially parallel to, or locates vertically to the absorption axis of the layer having the monoaxial absorption anistorpy, which has been formed on the substrate provided on the side of said observer.

17. A liquid crystal display apparatus according to claim 1 wherein:
a long axial direction of a liquid crystal molecule which constitutes said liquid crystal layer on an alignment control film formed on said paired substrates is located in a substantially vertical direction with respect to said alignment control film.

18. A liquid crystal display apparatus comprising:
one pair of substrates;
one pair of polarizing plates which are arranged on said one pair of substrates respectively;
a liquid crystal layer which is sandwiched by said one pair of substrates;
an electrode group which is formed on at least one of said one pair of substrates and is to apply an electric field to said liquid crystal layer; and
a light source which is arranged outside said one pair of substrates; wherein:
an absorption layer for compensating polarization degrees of said one pair of polarizing plates is formed on at least one of said paired polarizing plates.

19. A liquid crystal display panel comprising:
one pair of substrates;
one pair of polarizing plates which are arranged on said one pair of substrates respectively;
a liquid crystal layer which is sandwiched by said one pair of substrates; and
an electrode group which is formed on at least one of said one pair of substrates and is to apply an electric field to said liquid crystal layer; wherein:
a layer having monoaxial absorption anisotropy is provided between said one pair of polarizing plates.
